(19) United States
(12) Patent Application Publication
(10) Pub. No.: US 2026/0101168 A1
(43) Pub. Date: Apr. 9, 2026

(54) ROAMING CLIENT MONITORING SYSTEMS AND METHODS

(71) Applicant: Boost SubscriberCo L.L.C., Englewood, CO (US)

(72) Inventors: Kashif Shahzad, Aurora, CO (US); Dawood Shahdad, Aurora, CO (US); Sean Donnelly, Allen, TX (US); Borong Zheng, Littleton, CO (US)

(21) Appl. No.: 18/907,311

(22) Filed: Oct. 4, 2024

(51) Int. Cl. H04W 8/02

(52) U.S. Cl. CPC H04W 8/02

(57) ABSTRACT

A disclosed method may include receiving, by a mobile operator of at least a fifth generation HPLMN, a first API response to a first KPI API call that specifies a number of home subscribers registered with a first NF of the HPLMN and a second API response to a second KPI API call that specifies a total number of subscribers registered with a second and distinct NF of the HPLMN such that the total number of subscribers includes both home subscribers and roaming subscribers that are roaming on a VPLMN.

### BRIEF SUMMARY

This disclosure is generally directed to systems, methods, and computer-readable media relating to roaming client monitoring. The management of roaming subscribers in mobile networks may present significant challenges for operators. One such challenge is the accurate tracking of the number and proportion of roaming subscribers in real-time. Some methods, such as those relying on Call Detail Records (CDRs), may introduce delays in data availability, potentially ranging from hours to days. This delay may hinder an operator's ability to respond promptly to sudden changes in roaming patterns or unexpected surges in roaming traffic. The lack of real-time visibility into roaming subscriber numbers may lead to suboptimal resource allocation, potential service quality issues for roaming subscribers, and missed opportunities for timely interventions to manage network resources effectively. In scenarios where roaming traffic unexpectedly increases, operators relying on delayed data may struggle to adjust network parameters or allocate additional resources in a timely manner, potentially resulting in degraded service quality for both home and roaming subscribers.

To address the challenge of real-time monitoring of roaming subscribers, mobile network operators may implement a system that leverages key performance indicator (KPI) data from multiple network functions. This system may utilize application programming interface (API) calls to collect up-to-date subscriber information from network elements such as the Access and Mobility Management Function (AMF) and the IP Multimedia Subsystem (IMS) Serving-Call Session Control Function (S-CSCF). By comparing the number of home subscribers registered with one network function to the total number of subscribers registered with another, the system may calculate a real-time roaming ratio. This technique may enable operators to gain near-instantaneous insights into the proportion of roaming subscribers on their network. The real-time nature of this data may enable rapid detection of changes in roaming patterns, potentially enabling operators to respond more quickly to unexpected surges in roaming traffic or other anomalies. This improved visibility may lead to more efficient resource allocation, better service quality management, and the ability to proactively address potential issues before they impact subscriber experience.

Another challenge in managing roaming subscribers is the complexity of modern network architectures, particularly in 5G and beyond. As networks evolve to incorporate concepts such as network slicing, edge computing, and virtualized network functions, the task of monitoring and managing roaming subscribers across these diverse network elements becomes increasingly complex. Traditional monitoring systems may struggle to provide a comprehensive view of roaming activity across all network slices and services. This may result in blind spots where roaming issues in specific network segments or services may go unnoticed. Additionally, the increased number of network elements and interfaces in modern architectures may lead to a higher volume of data that needs to be processed and analyzed to gain meaningful insights into roaming behavior. Without a unified technique to monitor roaming across these diverse network components, operators may find it challenging to maintain consistent service quality and efficient resource utilization for roaming subscribers.

To tackle the complexity of monitoring roaming subscribers in modern network architectures, operators may implement a comprehensive observability framework. This framework may integrate data from various network functions, slices, and services to provide a holistic view of roaming activity across the entire network. The system may utilize advanced data collection and processing techniques, potentially leveraging technologies such as time-series databases and message queue systems, to efficiently handle the high volume of data generated by multiple network elements. By implementing slice-aware monitoring capabilities, the system may enable operators to track roaming ratios and patterns specific to different network slices or services. This granular technique to monitoring may enable more targeted management of roaming resources and quality of service across diverse network segments. The observability framework may also incorporate machine learning algorithms to detect patterns and anomalies in roaming behavior across different network slices and services, potentially enabling predictive management of roaming resources.

The geographic distribution of roaming subscribers may pose another significant challenge for mobile network operators. Roaming patterns may vary considerably across different regions within a network's coverage area, influenced by factors such as proximity to international borders, tourist hotspots, or business centers. Traditional monitoring techniques that provide only network-wide roaming statistics may fail to capture these regional variations, potentially leading to suboptimal resource allocation and missed opportunities for targeted interventions. Operators may struggle to identify localized spikes in roaming activity or areas where roaming subscribers consistently experience service quality issues. This lack of granular, location-specific roaming data may hinder an operator's ability to optimize network performance for both home and roaming subscribers across diverse geographic areas.

To address the challenges associated with geographic variations in roaming patterns, operators may implement a system that enables granular, location-based monitoring of roaming ratios. This technique may involve dividing the network coverage area into multiple geographic zones or regions and calculating roaming ratios specific to each zone. The system may leverage data from various network elements, potentially including cell site information and location services, to associate subscriber activity with specific geographic areas. By computing and analyzing roaming ratios at this granular level, operators may gain insights into regional variations in roaming patterns. This detailed view may enable more targeted resource allocation, enabling operators to adapt network parameters and capacity in response to localized roaming trends. The system may also incorporate visualization tools, such as heat maps or dynamic dashboards, to provide network operators with an intuitive understanding of roaming distribution across their coverage area. This geographic-aware technique to roaming management may potentially lead to improved service quality for roaming subscribers in high-traffic areas and more efficient utilization of network resources across diverse regions.

In some examples, a method comprises (i) receiving, by a mobile operator of at least a fifth generation Home Public Land Mobile Network (HPLMN), a first Application Programming Interface (API) response to a first (Key Performance Indicators) KPI API call that specifies a number of home subscribers registered with a first Network Function (NF) of the HPLMN and a second API response to a second KPI API call that specifies a total number of subscribers registered with a second and distinct NF of the HPLMN such that the total number of subscribers includes both home subscribers and roaming subscribers that are roaming on a Visited Public Land Mobile Network (VPLMN), (ii) computing, by the mobile operator, a ratio of home subscribers to total subscribers by comparing the number of home subscribers registered with the first NF as indicated by the first API response to the total number of subscribers registered with the second and distinct NF as indicated by the second API response such that the ratio represents a percentage of subscribers that are home subscribers, and (iii) performing, by the mobile operator in response to a determination that the ratio satisfies a predetermined threshold, a remediation action that resolves an alert resulting from an elevated number of roaming subscribers registered with the second and distinct NF as indicated by the ratio satisfying the predetermined threshold.

In some examples, the first KPI API call comprises a call provided by the first Network Function (NF).

In some examples, the second KPI API call comprises a call provided by the second and distinct NF.

In some examples, the first NF manages connections and mobility for home subscribers on the HPLMN.

In some examples, the first NF comprises an Access and Mobility Management Function (AMF).

In some examples, the second and distinct NF comprises an IP Multimedia Subsystem (IMS) Serving-Call Session Control Function (S-CSCF).

In some examples, the first NF has no visibility into a number of roaming subscribers currently registered on the VPLMN.

In some examples, the method comprises computing a ratio of roaming subscribers to total subscribers by subtracting the ratio of home subscribers to total subscribers from one.

In some examples, the predetermined threshold comprises a threshold between 15 and 35 percent.

In some examples, the remediation action comprises at least one of: checking for outages in a (Radio Access Network) (RAN), verifying interconnectivity between the HPLMN and partner networks, or examining authentication processes for roaming subscribers.

In some examples, the remediation action comprises restoring service to an impaired portion of the RAN of the HPLMN.

In some examples, the mobile operator computes the ratio at predefined intervals.

In some examples, the mobile operator computes the ratio at intervals between 1 and 30 minutes.

In some examples, the HPLMN comprises a network distributed across multiple availability zones of a cloud computing platform and the mobile operator computes the ratio separately for each availability zone such that the mobile operator detects elevated roaming levels specific to individual availability zones.

In some examples, the mobile operator collects the KPIs using an observability framework.

In some examples, the mobile operator identifies home subscribers and roaming subscribers by extracting Public Land Mobile Network (PLMN) identifiers from registration request messages received from subscriber devices and the mobile operator compares the extracted identifiers to a stored identifier of the HPLMN to determine subscriber roaming status.

In some examples, a non-transitory computer-readable storage medium has computer-executable instructions stored thereon that, when executed by at least one processor, cause the at least one processor to cause operations to be performed, the operations including: (i) receiving, by a mobile operator of at least a fifth generation Home Public Land Mobile Network (HPLMN), a first Application Programming Interface (API) response to a first Key Performance Indicators (KPI) API call that specifies a number of home subscribers registered with a first Network Function (NF) of the HPLMN and a second API response to a second KPI API call that specifies a total number of subscribers registered with a second and distinct NF of the HPLMN such that the total number of subscribers includes both home subscribers and roaming subscribers that are roaming on a Visited Public Land Mobile Network (VPLMN), (ii) computing, by the mobile operator, a ratio of home subscribers to total subscribers by comparing the number of home subscribers registered with the first NF as indicated by the first API response to the total number of subscribers registered with the second and distinct NF as indicated by the second API response such that the ratio represents a percentage of subscribers that are home subscribers, and (iii) performing, by the mobile operator in response to a determination that the ratio satisfies a predetermined threshold, a remediation action that resolves an alert resulting from an elevated number of roaming subscribers registered with the second and distinct NF as indicated by the ratio satisfying the predetermined threshold.

In some examples, a system comprises at least one memory that stores computer executable instructions and at least one processor that executes the computer executable instructions to cause operations to be performed, the operations including: (i) receiving, by a mobile operator of at least a fifth generation HPLMN, a first API response to a first KPI API call that specifies a number of home subscribers registered with a first NF of the HPLMN and a second API response to a second KPI API call that specifies a total number of subscribers registered with a second and distinct NF of the HPLMN such that the total number of subscribers includes both home subscribers and roaming subscribers that are roaming on a VPLMN, (ii) computing, by the mobile operator, a ratio of home subscribers to total subscribers by comparing the number of home subscribers registered with the first NF as indicated by the first API response to the total number of subscribers registered with the second and distinct NF as indicated by the second API response such that the ratio represents a percentage of subscribers that are home subscribers, and (iii) performing, by the mobile operator in response to a determination that the ratio satisfies a predetermined threshold, a remediation action that resolves an alert resulting from an elevated number of roaming subscribers registered with the second and distinct NF as indicated by the ratio satisfying the predetermined threshold.

### BRIEF DESCRIPTION OF THE DRAWINGS

For a better understanding of the present invention, reference will be made to the following Detailed Description, which is to be read in association with the accompanying drawings:

FIG. 1 shows a flow diagram for a method relating to roaming client monitoring.

FIG. 2 is a multi-panel illustration depicting a comprehensive view of a roaming ratio monitoring process implemented in a network operations center.

FIG. 3 is a flowchart showing the detailed process of calculating roaming ratios and initiating remedial actions based on predetermined thresholds.

FIG. 4 is a multi-panel illustration showcasing various remedial actions that may be taken in response to elevated roaming levels.

FIG. 5 is a detailed diagram illustrating the interaction between Home Public Land Mobile Network (HPLMN) and Visited Public Land Mobile Network (VPLMN) in roaming scenarios.

FIG. 6 is a multi-panel illustration demonstrating how roaming ratio calculations may be applied across different network slices and services in a 5G network environment.

FIG. 7 is a multi-panel illustration showing segmented roaming ratio analysis across different geographic regions and customer segments.

FIG. 8 is a detailed illustration of an observability framework and Key Performance Indicator (KPI) data collection process used in roaming ratio monitoring.

FIG. 9 is a multi-panel illustration depicting the process of identifying home and roaming subscribers using Public Land Mobile Network (PLMN) identifiers.

FIG. 10 is a block diagram of an example computer system suitable for implementing various aspects of the roaming subscriber monitoring and management system.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

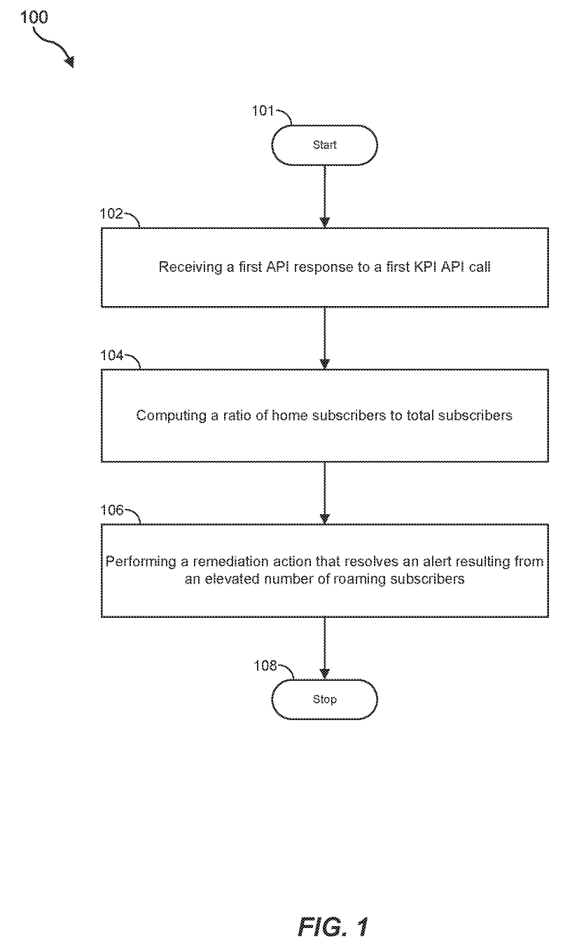

FIG. 1 shows a flow diagram for an example method 100 relating to roaming client monitoring. At step 101, method 100 may start. At step 102, method 100 may include receiving, by a mobile operator of at least a fifth generation Home Public Land Mobile Network (HPLMN), a first Application Programming Interface (API) response to a first Key Performance Indicators (KPI) API call that specifies a number of home subscribers registered with a first Network Function (NF) of the HPLMN and a second API response to a second KPI API call that specifies a total number of subscribers registered with a second and distinct NF of the HPLMN such that the total number of subscribers includes both home subscribers and roaming subscribers that are roaming on a Visited Public Land Mobile Network (VPLMN). At step 104, method 100 may include computing, by the mobile operator, a ratio of home subscribers to total subscribers by comparing the number of home subscribers registered with the first NF as indicated by the first API response to the total number of subscribers registered with the second and distinct NF as indicated by the second API response such that the ratio represents a percentage of subscribers that are home subscribers. At step 106, method 100 may include performing, by the mobile operator in response to a determination that the ratio satisfies a predetermined threshold, a remediation action that resolves an alert resulting from an elevated number of roaming subscribers registered with the second and distinct NF as indicated by the ratio satisfying the predetermined threshold. At step 108, method 100 may end.

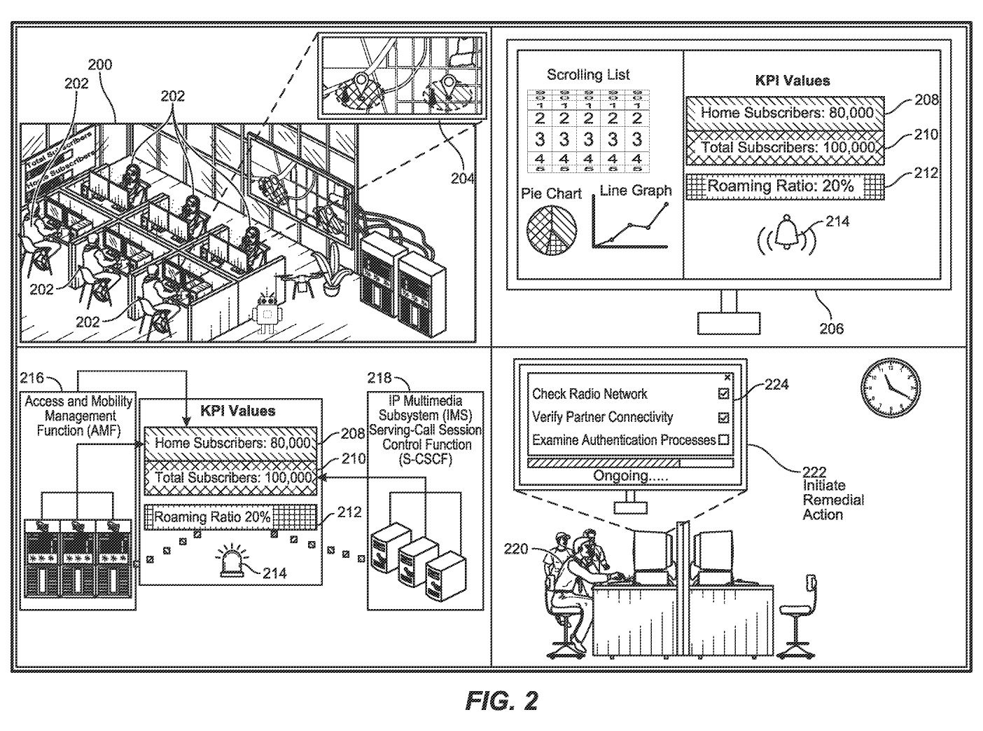

FIG. 2 illustrates a view of a roaming ratio monitoring process that may be implemented by a mobile operator of at least a fifth generation home public land mobile network (HPLMN). This figure may provide a visual representation of components and processes that may be involved in receiving application programming interface (API) responses, computing roaming ratios, and initiating remedial actions based on predetermined thresholds. The illustration may encompass various aspects of the monitoring system, from the physical environment of the network operations center to the data processing and decision-making procedures that may enable management of roaming subscribers.

As shown in the first panel of FIG. 2 (clockwise starting top left), the process may begin in a network operations center (NOC) 200 of the mobile operator. The NOC 200 may serve as a hub for monitoring and managing network performance, including roaming activities. Within this environment, technicians 202 may operate workstations equipped with monitoring and control systems. A central display 204 may present a real-time map of the network coverage area, potentially distinguishing between home network regions and roaming areas through hatching or color-coding. This visual representation may enable identification of potential issues and trends in subscriber distribution across the network.

The NOC 200 may be implemented in various ways to suit the needs and scale of the mobile operator. In some implementations, the NOC 200 may be a physical location housing equipment and personnel, providing a point for real-time monitoring and response to network issues. Alternatively, it may be a distributed system with technicians operating remotely from different locations, potentially leveraging secure virtual private networks and cloud-based monitoring tools to maintain oversight of network operations. The NOC 200 may also incorporate virtualized components, enabling for scaling and management of network monitoring resources. This virtualization may enable allocation of computing resources based on network load and monitoring requirements, potentially affecting efficiency and cost-effectiveness. The NOC 200 may serve as a point for receiving and processing network data, including the information used for roaming ratio calculations.

The top right panel of FIG. 2 may focus on a workstation monitor 206, which may display performance indicators for roaming ratio monitoring. The workstation monitor 206 may show two primary data points: the number of home subscribers 208 and the total number of subscribers 210. These values may correspond to the first and second API responses received by the mobile operator. The visual presentation of these indicators may be customized to suit different operational needs, potentially including real-time trend graphs, geographic heat maps, or comparative benchmarks against historical data or industry standards. The display may also incorporate color-coding or visual alerts to draw attention to changes or anomalies in subscriber numbers.

The mobile operator may receive a first Application Programming Interface (API) response to a first Key Performance Indicators (KPI) API call that specifies a number of home subscribers registered with a first network function of the Home Public Land Mobile Network (HPLMN). This information may be represented by the "Home Subscribers: 80,000" display 208 on the workstation monitor 206. The mobile operator may also receive a second API response to a second KPI API call that specifies a total number of subscribers registered with a second and distinct network function of the HPLMN. This total number, which may include both home subscribers and roaming subscribers that are roaming on a visited public land mobile network (VPLMN), may be represented by the "Total Subscribers: 100,000" display 210. The process of receiving and processing these API responses may involve data aggregation and normalization procedures to promote accuracy and consistency across different network elements and time periods. The system may employ data validation techniques to identify and handle anomalies or inconsistencies in the reported subscriber numbers.

The concept of API calls and responses in this context may refer to a method of requesting and receiving data from sources including various network functions. APIs (Application Programming Interfaces) may provide a way for different software systems or components to communicate with each other. In mobile networks, APIs may enable the monitoring system to query specific network functions for real-time data. These API calls may be implemented using various protocols, such as Representational State Transfer (REST)ful Hypertext Transfer Protocol (HTTP) requests, Simple Object Access Protocol (SOAP), or Google's Remote Procedure Call framework (gRPC), depending on the network architecture and requirements. The choice of API technology may affect factors such as data transfer speed, security, and compatibility with different network elements. API design considerations may include rate limiting to manage system load, authentication and authorization mechanisms to promote data security, and versioning strategies to support backward compatibility as the system evolves. The implementation of these APIs may also incorporate redundancy and failover mechanisms to support data availability even in the event of partial network outages or equipment failures.

Using the data received from these API calls, the mobile operator may compute a ratio of home subscribers to total subscribers. This computation may be visually represented by the "Roaming Ratio: 20%" display 212. The roaming ratio may be calculated by comparing the number of home subscribers registered with the first network function to the total number of subscribers registered with the second and distinct network function. This ratio may represent a percentage of subscribers that are home subscribers, with the complement (in this case, 20%) potentially representing the percentage of roaming subscribers. The calculation of this ratio may be performed in real-time or near-real-time, depending on the frequency of API calls and the processing capabilities of the monitoring system. The system may employ data smoothing or averaging techniques to account for short-term fluctuations and provide a representation of the overall roaming situation.

The computation of the roaming ratio may be performed using various algorithms and data processing techniques. In one form, it may involve dividing the number of home subscribers by the total number of subscribers and subtracting the result from one to get the roaming ratio. However, other calculations may be employed to account for factors such as temporary network outages, subscribers in transit, or roaming agreements. The computation may also involve data smoothing techniques to address the impact of short-term fluctuations and provide a stable representation of the roaming situation. Some implementations might incorporate machine learning algorithms to identify patterns and trends in roaming behavior, potentially enabling predictive analytics for future roaming ratios based on historical data, current network conditions, and external factors such as events or seasonal trends. The system may also apply different weighting factors to various subscriber types or geographic regions to provide a view of roaming activity across the network.

Adjacent to the roaming ratio display, there may be a flashing alert icon 214, which may indicate that the computed ratio has satisfied a predetermined threshold. This visual cue may prompt the initiation of remedial actions by the mobile operator. The threshold may be set based on various factors, including historical data, network capacity, roaming agreements, and business objectives. It may be a fixed value or dynamically adjusted based on time of day, network conditions, or other relevant parameters. The alert system may be configured with multiple threshold levels, each potentially triggering different types of notifications or actions depending on the roaming situation. The visual alert may be accompanied by audible alarms, automated notifications to personnel, or integration with incident management systems to initiate response protocols.

The bottom left panel of FIG. 2 may provide a schematic representation of the network functions involved in providing the KPI data. The first network function 216, labeled as the Access and Mobility Management Function (AMF), may be responsible for providing the home subscriber count. The second and distinct network function 218, labeled as the IP Multimedia Subsystem (IMS) Serving-Call Session Control Function (S-CSCF), may provide the total subscriber count. This visual representation may help illustrate the roles of these network functions in the roaming ratio calculation process and their relationship to the overall network architecture. The diagram may be simplified for clarity, and in actual implementations, these functions may interact with other network elements and subsystems to fulfill their roles.

These network functions may play roles in modern mobile networks, particularly in 5G architectures. The AMF 216 may be a component of the 5G core network, potentially managing user authentication, authorization, and mobility. It may maintain information about the connectivity status of user equipment (UE) within the home network, potentially making it a source for home subscriber data. The AMF 216 may interact with other network functions, such as the Session Management Function (SMF) and the Unified Data Management (UDM), to manage subscriber sessions and maintain location information. The IMS S-CSCF 218 may be part of the IP Multimedia Subsystem (IMS) and may manage session control for all subscribers, including both home and roaming users. This may make it suitable for providing the total subscriber count. The IMS S-CSCF 218 may interact with various other IMS components, such as the Proxy-CSCF (P-CSCF) and the Interrogating-CSCF (I-CSCF), to manage multimedia sessions and ensure proper routing of signaling messages.

It's worth noting that while these specific network functions are mentioned in this implementation, the invention may not be limited to these particular elements. Future network architectures may introduce new functions or combine existing ones, and the roaming ratio monitoring system may be adaptable to such changes. The key aspect may be the ability to obtain counts of home subscribers and total subscribers from appropriate network elements, regardless of their specific designations.

The bottom right panel of FIG. 2 may illustrate the initiation of remedial action in response to the roaming ratio exceeding the predetermined threshold. A technician 220 may be shown activating the "Initiate Remedial Action" control 222 on their workstation. This action may trigger a series of predefined processes aimed at addressing the elevated number of roaming subscribers.

The mobile operator may perform a remediation action in response to a determination that the ratio satisfies a predetermined threshold. This remediation action may resolve an alert resulting from an elevated number of roaming subscribers registered with the second and distinct network function, as indicated by the ratio satisfying the predetermined threshold.

Remedial actions may encompass a range of interventions, depending on the root cause of the elevated roaming levels. As shown in the action items display 224, these may include checking the radio network for coverage issues, verifying connectivity with partner networks, and examining authentication processes. The specific actions taken may be automated, manual, or a combination of both, depending on the complexity of the issue and the level of human oversight that may be desired.

When the roaming ratio exceeds the threshold, an alert 214 may be automatically generated by the monitoring system. The system may classify the alert based on factors such as severity, affected regions, and potential causes. Based on the classification, the system may suggest appropriate remedial actions. In some cases, it may automatically initiate certain actions. A technician 220 may review the suggested actions and potentially modify or approve them based on their expertise and additional context. The approved actions may then be executed, which may involve adjusting network parameters, communicating with partner networks, or dispatching field technicians. The system may continue to monitor the roaming ratio and related metrics to assess the effectiveness of the remedial actions. Based on the outcomes of previous interventions, the system may learn and refine its action recommendations for future incidents.

This technique to monitoring and managing roaming ratios may enable mobile operators to maintain network performance, support service quality for both home and roaming subscribers, and manage resources across their network infrastructure. The visual representation provided in FIG. 2 may help illustrate the complex interplay between automated systems and human oversight in managing modern mobile networks, particularly in the context of roaming subscriber management.

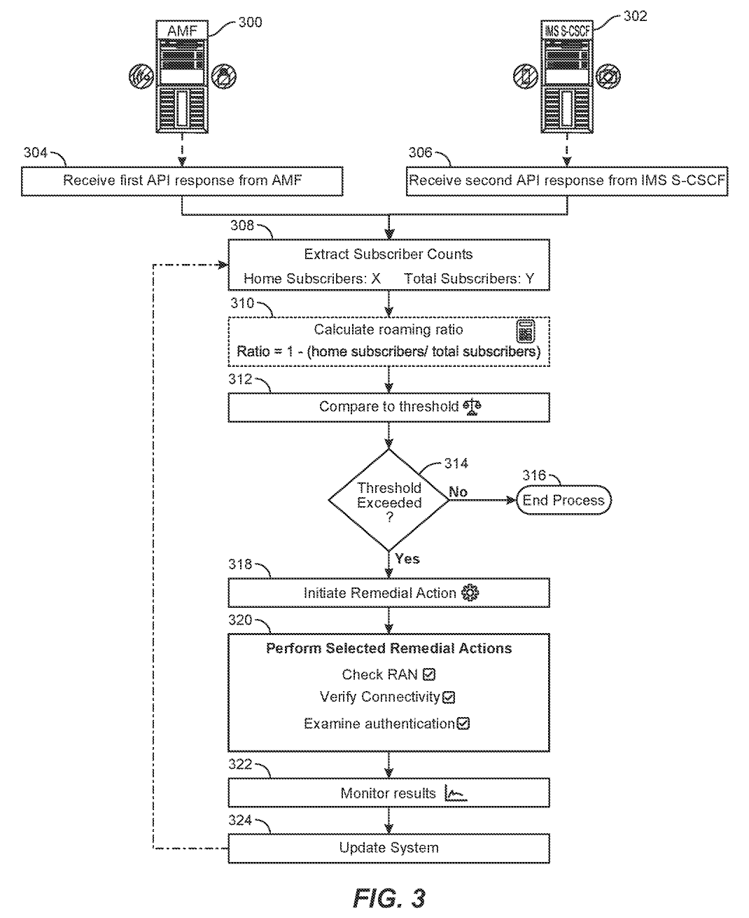

FIG. 3 illustrates a technical diagram of the roaming ratio calculation and response process implemented by a mobile operator of at least a fifth generation home public land mobile network (HPLMN). This figure may provide a detailed example representation of the steps involved in receiving key performance indicator (KPI) data, computing the roaming ratio, and initiating remedial actions based on predetermined thresholds. The diagram offers a comprehensive view of an example of data flow and decision-making processes that underpin the roaming management system.

At the top of the diagram, two network functions are depicted: the Access and Mobility Management Function (AMF) 300 and the IP Multimedia Subsystem (IMS) Serving-Call Session Control Function (S-CSCF) 302. These network functions may serve as the primary sources of the KPI data used in the roaming ratio calculation. The AMF 300 may be responsible for managing mobility and access control in the 5G core network, maintaining detailed information about the connectivity status and location of user equipment (UE) within the home network. This makes it a suitable source for data regarding home subscribers. On the other hand, the IMS S-CSCF 302 may handle session control for both home and roaming subscribers, managing the establishment, maintenance, and termination of multimedia sessions across the network. Its comprehensive view of all active subscribers, regardless of their roaming status, positions it as a source for total subscriber count data.

The process may begin with the receipt of API responses from these network functions, initiating a sequence of data collection, processing, and decision-making steps. The mobile operator may receive a first API response 304 to a first KPI API call from the AMF 300. This response may specify a number of home subscribers registered with the AMF 300, providing a snapshot of the current home subscriber base. Simultaneously, the mobile operator may receive a second API response 306 to a second KPI API call from the IMS S-CSCF 302. This response may specify the total number of subscribers registered with the IMS S-CSCF 302, encompassing both home and roaming subscribers and offering a comprehensive view of the network's active user base. The API calls and responses may be implemented using various protocols, such as Representational State Transfer (REST)ful Hypertext Transfer Protocol (HTTP) requests, Simple Object Access Protocol (SOAP), or Google's Remote Procedure Call framework (gRPC), depending on the specific network architecture and requirements. The choice of protocol may affect factors such as data transfer speed, security, and compatibility with different network elements.

Once the API responses are received, the system may proceed to extract the subscriber counts 308 from the responses, initiating the data processing phase of the roaming ratio calculation. This step may involve parsing the API response data and extracting the relevant subscriber count information, potentially dealing with complex data structures or large volumes of information. The extraction process may include rigorous data validation checks to ensure the accuracy and consistency of the received information, possibly employing techniques such as schema validation, data type checking, and range verification. Additionally, the system might implement data normalization procedures to ensure that the subscriber counts from different network functions are comparable and may be used reliably in the subsequent ratio calculation.

With the subscriber counts extracted and validated, the mobile operator may then calculate the roaming ratio 310, a metric that forms the basis for subsequent decision-making processes. This calculation may involve dividing the number of home subscribers (obtained from the AMF) by the total number of subscribers (obtained from the IMS S-CSCF), and then subtracting this value from 1 to get the ratio of roaming subscribers. The formula used may be represented as: Roaming Ratio = 1 - (Home Subscribers / Total Subscribers). This seemingly simple calculation belies the complex data aggregation and processing that precedes it, as well as the significant implications it has for network management and resource allocation. The calculation may be performed in real-time or near-real-time, depending on the frequency of the API calls and the processing capabilities of the system. The mobile operator may compute this ratio at predefined intervals, which may range from 1 to 30 minutes, for example. The specific interval chosen may depend on a multitude of factors, such as the desired responsiveness of the system, the rate of change in subscriber numbers, the computational resources available, and the potential impact on other network operations. In more advanced implementations, the calculation frequency might be dynamically adjusted based on current network conditions or historical patterns of roaming behavior.

After computing the roaming ratio, the system may compare it to a predetermined threshold 312, initiating the analytical phase of the process where data-driven decisions are made. The predetermined threshold 312 may be set based on a complex interplay of factors, including historical data trends, current network capacity, existing roaming agreements with partner networks, and overarching business objectives of the mobile operator. The predetermined threshold 312 may be a fixed value, providing a consistent benchmark for roaming management, or it could be dynamically adjusted based on time of day, specific network conditions, or even external factors such as major events or seasonal variations that might influence roaming patterns. In some implementations, the predetermined threshold 312 may be set between 15 and 35 percent, offering a range that may accommodate different network configurations and business models. The predetermined threshold 312 comparison process may involve sophisticated statistical analysis, potentially incorporating techniques such as moving averages or exponential smoothing to mitigate the impact of short-term fluctuations and focus on meaningful trends in roaming behavior.

The comparison process may culminate in a decision point 314 where the system determines whether the calculated roaming ratio exceeds the predetermined threshold 312. This binary decision serves as a trigger for potential interventions in the network's operation. If the the predetermined threshold 312 is not exceeded, the process may end 316, and the system may continue its regular monitoring cycle, maintaining vigilance over the network's roaming status. However, if the roaming ratio does exceed the predetermined threshold 312, the system may proceed to initiate remedial action 318, transitioning from a monitoring and analysis phase to an active intervention phase. This decision point 314 represents a juncture where automated systems may interact with human oversight, potentially alerting network operators or triggering predefined automated responses depending on the severity and nature of the threshold breach.

The initiation of the remedial action 318 may involve a complex decision-making process, selecting and executing one or more predefined actions aimed at addressing the elevated roaming levels. These actions may encompass a wide range of interventions, such as conducting comprehensive checks for outages in the Radio Access Network (RAN), verifying and potentially optimizing interconnectivity between the Home Public Land Mobile Network (HPLMN) and partner networks, or examining and refining authentication processes for roaming subscribers. The selection of specific remedial actions may be guided by sophisticated algorithms that take into account factors such as the magnitude of the threshold breach, historical effectiveness of different interventions, current network load, and/or potential impact on service quality for both home and roaming subscribers. In more advanced implementations, machine learning techniques might be employed to continuously refine the selection and prioritization of remedial actions based on their observed effectiveness in similar situations.

Once remedial actions are initiated, the system may proceed to perform the selected remedial actions 320. This step may involve executing a coordinated series of interventions, which may comprise automated processes, manual actions performed by skilled technicians, or an orchestrated combination of both. The execution of these actions might require intricate coordination across various network elements and potentially with external partner networks. For instance, addressing Radio Access Network (RAN) issues might involve dynamic reallocation of network resources, adjustment of cell tower parameters, or even the activation of temporary cell sites in areas experiencing high roaming traffic. Interconnectivity verifications could entail running comprehensive diagnostic routines on inter-operator links, potentially leveraging software-defined networking (SDN) capabilities to dynamically optimize routing paths. Authentication process examinations might necessitate detailed audits of signaling traffic, potentially leading to updates in subscriber profile databases or refinements to roaming agreement implementations.

After the remedial actions 320 are performed, the system may transition into a phase of intensified monitoring to assess the results 322. This ongoing monitoring may help evaluate the effectiveness of the implemented actions and determine if additional interventions are necessary. The monitoring process may involve continued collection and analysis of key performance indicator (KPI) data from the network functions, potentially at an increased frequency compared to normal operations. Advanced analytics techniques might be applied to this data, such as time series analysis to detect trends in roaming ratios following the interventions, or anomaly detection algorithms to quickly identify any unexpected consequences of the remedial actions 320. This phase may also involve cross-referencing the roaming data with other network performance metrics to ensure that the remedial actions 320 haven't adversely affected other aspects of network operation.

Finally, the system may update itself 324 based on the results of the remedial actions and ongoing monitoring, embodying a self-improving, adaptive technique to network management. This update may encompass a wide range of adjustments, including refining threshold values to better reflect the network's operational realities, modifying the prioritization or parameters of remedial action strategies, or recalibrating monitoring intervals and data collection processes to optimize the balance between responsiveness and system resource utilization. In more sophisticated implementations, this self-update mechanism might leverage machine learning algorithms, potentially employing techniques such as reinforcement learning to continuously optimize the system's response to roaming challenges over time. The update process might also involve generating detailed reports and insights that may inform broader strategic decisions about network infrastructure investments, roaming partnership negotiations, or service offering developments.

Throughout this intricate process, the mobile operator may employ a diverse array of data processing techniques to ensure the accuracy, reliability, and relevance of the roaming ratio calculation and subsequent decision-making. These techniques may include advanced data smoothing algorithms to reduce the impact of short-term fluctuations, potentially utilizing methods such as exponential moving averages. Trend analysis techniques might be applied to identify long-term patterns in roaming behavior, possibly incorporating seasonal decomposition methods to account for cyclical variations in roaming activity. Anomaly detection algorithms, which could range from simple statistical methods to complex machine learning models like autoencoders or isolation forests, may be employed to quickly identify unusual spikes or dips in roaming activity that warrant immediate attention.

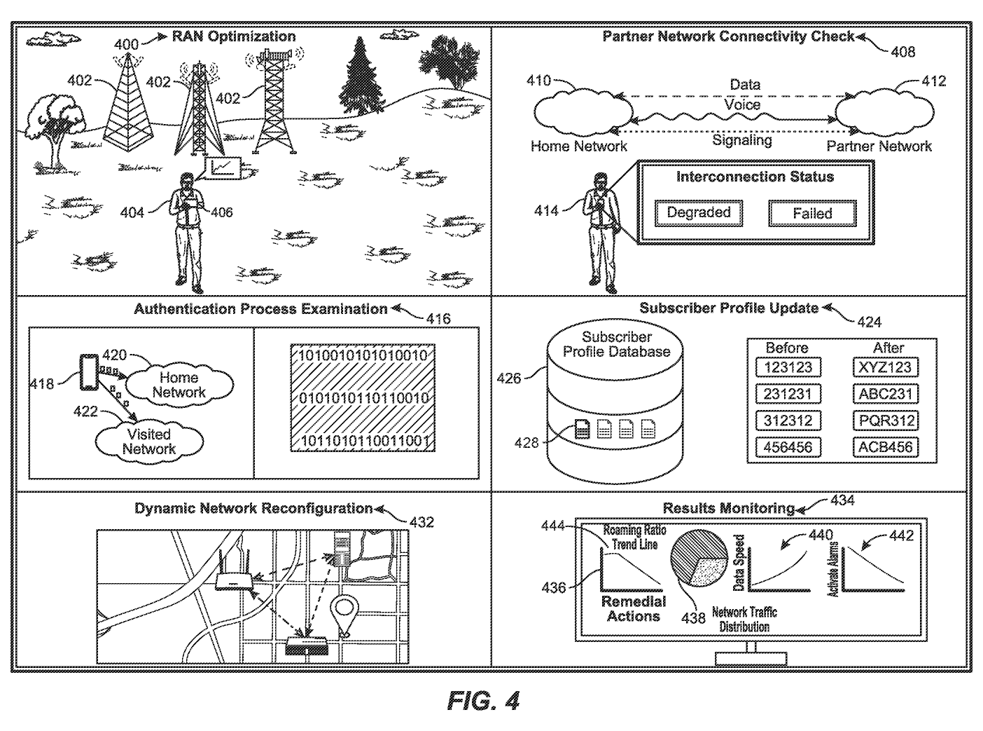

FIG. 4 illustrates a multi-panel representation of various remedial actions that may be taken by a mobile operator in response to elevated roaming levels detected through the roaming ratio monitoring system. This figure provides an overview of example interventions that may be implemented to address issues contributing to higher-than-expected roaming ratios, illustrating the potentially complex and multifaceted nature of roaming management in modern mobile networks.

The top left panel of FIG. 4, focusing on RAN Optimization 400, depicts the process of optimizing the Radio Access Network (RAN) in response to elevated roaming levels. This panel shows a landscape view with multiple cell towers 402 distributed across the scene, representing the physical infrastructure of the mobile network. Some towers are illustrated with visible issues, such as broken antennas or warning lights, to indicate potential problems that could contribute to increased roaming. In the foreground, a technician 404 may be seen using a tablet device 406 to remotely adjust tower settings. This visual representation underscores the potential for real-time, remote interventions in network infrastructure. The tablet device 406 may display various parameters that may be adjusted, such as transmission power, antenna tilt, or frequency allocations. Above the technician 404, a small chart is included to show signal strength improving as adjustments are made, visually demonstrating the immediate impact of these optimizations. This process of RAN optimization may involve complex algorithms that analyze current network conditions, subscriber distribution, and historical performance data to determine the most effective adjustments. The goal of these optimizations may be to improve coverage and capacity in areas experiencing high roaming traffic, potentially reducing the likelihood of home subscribers connecting to partner networks due to inadequate home network coverage.

The top right panel, illustrating Partner Network Connectivity Check 408, depicts the process of verifying and potentially optimizing interconnections between the home network and partner networks. This panel shows two distinct network infrastructures: the home network 410 and a partner network 412. These networks may be represented as interconnected clouds or clusters of network elements, emphasizing the complex nature of inter-operator connections. Multiple lines connecting these networks may represent different types of connections, such as data, voice, and signaling links. A network engineer 414 may execute diagnostic tools, representing the human oversight and expertise involved in managing these inter-operator links. The network engineer 414 tablet device 406 screen may display a pop-up window showing "Interconnection Status" with some connections marked as "Degraded" or "Failed". This visual element underscores the importance of maintaining robust connections with partner networks to ensure smooth handovers and optimal routing of roaming traffic. The connectivity check process may involve running comprehensive tests on signaling links, verifying the correct implementation of roaming agreements in border gateways, and ensuring that traffic is being routed efficiently between networks. By identifying and addressing connectivity issues, mobile operators may reduce unnecessary roaming and improve the overall experience for subscribers moving between networks.

The middle left panel of FIG. 4, focusing on Authentication Process Examination 416, provides a visual representation of example procedures involved in authenticating roaming subscribers. This panel may be designed as a split-screen view to illustrate both the high-level process flow and the underlying technical details. On one side of the panel, a simplified representation of the authentication process may be shown, depicting icons for a mobile device 418, the home network 420, and a visited network 422. Arrows connecting these elements may be used to show the flow of authentication data. This high-level view may help illustrate the sequence of steps involved in authenticating a roaming subscriber, from initial attachment to the visited network through to successful registration and service access. On the other side of the panel, lines of code or a detailed flowchart may be displayed, representing the authentication algorithm or protocol being examined. A section of this code or flowchart may be highlighted to indicate a potential issue or area for optimization. This detailed view may underscore the complexity of the authentication process and the potential for small discrepancies or inefficiencies to impact roaming performance. The authentication process examination may involve analyzing signaling traces, verifying the correct implementation of authentication protocols, and identifying any bottlenecks or errors in the authentication flow. By optimizing this process, mobile operators may reduce authentication failures or delays, potentially improving the roaming experience and reducing unnecessary load on network resources.

The middle right panel, illustrating Subscriber Profile Update 424, depicts the process of reviewing and updating subscriber profiles to ensure accurate roaming permissions and preferences. This panel may show a large database icon 426 representing the subscriber profile database, emphasizing the vast amount of subscriber data managed by mobile operators. Multiple subscriber profiles may be shown as small document icons, with one profile 428 highlighted and expanded to show its contents. The panel includes a before-and-after view of the profile, with changes highlighted to demonstrate the specific updates being made. These updates could include modifying roaming permissions, updating preferred network lists, or adjusting service restrictions for roaming scenarios. The subscriber profile update 424 process may involve complex data management procedures, potentially leveraging machine learning algorithms to identify profiles that may benefit from updates based on historical usage patterns or recent network changes. By ensuring that subscriber profiles accurately reflect current roaming agreements and individual subscriber needs, mobile operators may optimize the roaming experience and reduce instances of unnecessary roaming or service access issues.

The bottom left panel, focusing on Dynamic Network Reconfiguration 432, provides a visual representation of real-time adjustments to network topology and traffic routing in response to changing roaming patterns. This panel may show a network topology map covering the entire area, depicting various network elements such as routers, switches, and servers connected by lines representing data links. The dynamic network reconfiguration 432 process may involve sophisticated traffic engineering algorithms that analyze current network conditions, roaming patterns, and available resources to determine optimal routing strategies. These reconfigurations could include adjusting load balancing parameters, modifying quality of service settings for roaming traffic, or activating additional network resources in areas experiencing high roaming demand. By dynamically adapting the network configuration to changing roaming conditions, mobile operators may improve overall network efficiency and enhance the quality of service for both home and roaming subscribers.

The bottom right panel, illustrating Results Monitoring 434, depicts the ongoing process of assessing the impact of implemented remedial actions. This panel may be designed as a large monitoring dashboard, providing a comprehensive view of various network performance metrics. Key elements of this dashboard may include a roaming ratio trend line 444 showing a decrease after remedial actions 436 have been implemented, demonstrating the effectiveness of the interventions. A network traffic distribution pie chart 438 may be included to show the current balance between home and roaming traffic. Data speed 440 may be displayed in chart form to provide a holistic view of network performance. An alarm status panel 442 showing a reduced number of active alarms may also be included, visually representing the improvement in network health following the remedial actions. The results monitoring 434 process may involve complex data analytics techniques, potentially incorporating machine learning algorithms to identify correlations between implemented actions and observed network improvements. By continuously monitoring the results of remedial actions 436, mobile operators may refine their roaming management strategies over time, leading to increasingly effective interventions and overall improvements in network performance and subscriber experience.

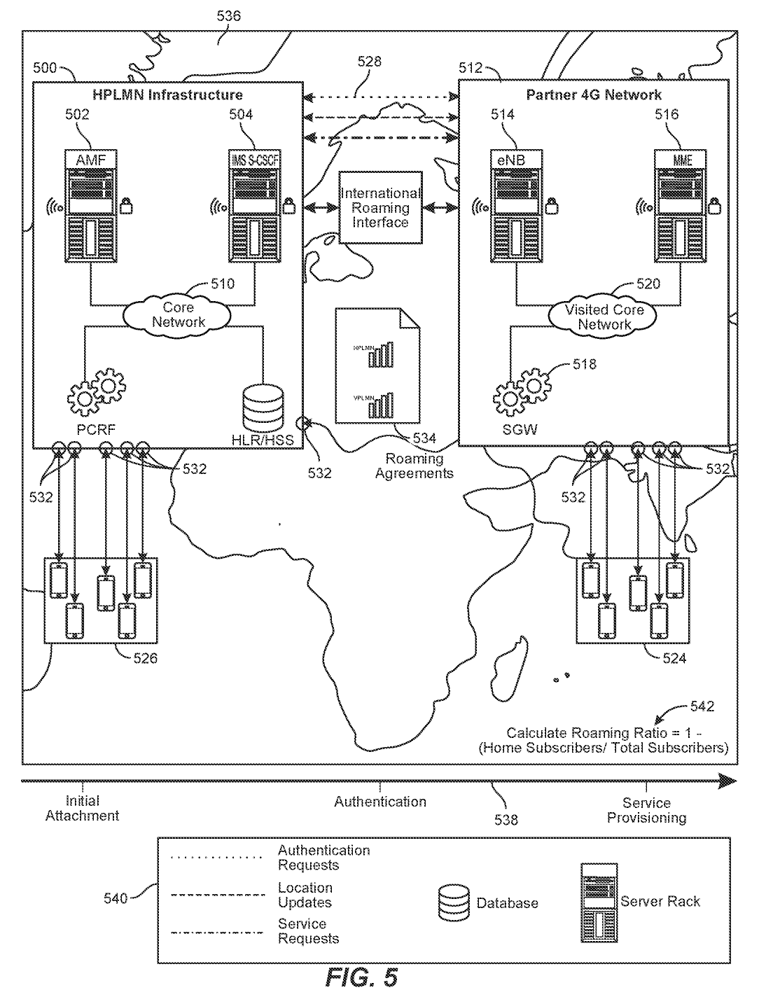

FIG. 5 presents a comprehensive illustration of the interaction between the 5G Network (home network) and a Partner 4G Network in various roaming scenarios. This figure provides a detailed visual representation of the complex interplay between network elements, signaling flows, and subscriber interactions that occur during roaming between networks of different generations. The illustration encapsulates the multifaceted nature of modern mobile network architectures and the intricate processes involved in managing roaming subscribers across different operator networks and technologies.

On the left side of the illustration, the 5G Network Home Public Land Mobile Network (HPLMN) infrastructure 500 is depicted, showcasing the components that may be involved in managing home subscribers and facilitating roaming services. This section includes several network functions. The Access and Mobility Management Function (AMF) 502 is represented as a server rack or network node. The AMF 502 handles tasks such as registration management, connection management, reachability management, and mobility event notification. Its placement within the Core Network 510 emphasizes its responsibility for home subscribers while also highlighting its involvement in the roaming process. Adjacent to the AMF 502, the IP Multimedia Subsystem (IMS) Subsystem Serving-Call Session Control Function (S-CSCF) 504 may be depicted, accentuating its function in session management for both home and roaming subscribers. The IMS S-CSCF 504 may play a role in handling Session Initiation Protocol (SIP) signaling, managing subscriber profiles, and coordinating multimedia sessions.

On the right side of the figure, the Partner 4G Network 512 is illustrated with components that reflect the 4G LTE architecture, adapted for handling roaming subscribers from the Visited Core Network 520. This representation helps to emphasize the interoperability between different generation networks while highlighting the specific roles each plays in managing roaming subscribers. The Partner 4G Network 512 section includes an eNodeB (eNB) 514, which serves as the access point for user equipment in the 4G LTE network. This component may play a role in facilitating radio access for roaming subscribers within the Partner 4G Network 512 coverage area. The Mobility Management Entity (MME) 516 is depicted to show how mobility management and bearer management are handled for roaming subscribers in the Partner 4G network 512. The MME 516 is responsible for control plane functions, including subscriber authentication, bearer establishment, and handover signaling. The Serving Gateway (SGW) 518 is included to demonstrate how user plane traffic is managed in the Partner 4G network 512. These components collectively represent the Partner 4G Network 512.

Central to the figure is the interface between the 5G Network Home Public Land Mobile Network (HPLMN) infrastructure 500 and the Partner 4G Network 512, which may be represented as a series of bidirectional arrows or data streams connecting the two networks. This interface is helpful in illustrating the various types of information exchanged between the Core Network 510 and Core Network 520, such as authentication requests, location updates, and service provisioning data. Scattered across the Partner 4G Network 512 area, multiple device icons may represent Roaming Subscribers 524. These icons may be connected to the Partner 4G Network 512 infrastructure through small arrows, visually demonstrating their connection to the visited network. This representation may help illustrate concepts such as the initial attachment process, where a subscriber first connects to the Partner 4G Network 512, triggering a series of authentication and registration procedures with the 5G Network HPLMN infrastructure 500. Similarly, in the 5G Network HPLMN infrastructure 500 area, device icons may represent Home Subscribers 526, connected to the home network infrastructure.

The figure employs different styles of arrows or lines to represent various types of Signaling Flows 528 between network elements. The signaling flows 528 may be designed to illustrate roaming procedures such as the initial authentication of a roaming subscriber (corresponding to interactions between the partner MME 516, home AMF 502, and home IMS S-CSCF 504), location update processes that keep the 5G Network HPLMN infrastructure 500 informed of the subscriber's whereabouts, and service request handling that may involve both visited core network 520 and home core network 510 elements.

To highlight the points at which roaming ratio calculations occur, small "KPI" tags 532 may be added at relevant points in both networks. These tags may be placed near the AMF 502 and IMS S-CSCF 504 in the 5G Network HPLMN infrastructure 500 and near the MME 516 in the Partner 4G Network 512, visually indicating the sources of data used in roaming ratio calculations. This aspect of FIG. 5 may help tie the network architecture illustration back to the core concept of roaming ratio monitoring, showing how data from various network elements is aggregated to produce meaningful metrics for network management and optimization.

Near the center of the illustration, a visual representation of Roaming Agreements 534 is included as a document icon with identifiers of both networks. This element may underscore the contractual and business aspects that underpin technical roaming implementations, particularly highlighting the complexities involved in agreements between operators with different generation networks. It may serve as a reminder that roaming capabilities are not solely a technical consideration but also involve complex business relationships and agreements between operators. The inclusion of this element in FIG. 5 may help viewers understand the broader context in which roaming technologies operate.

To provide geographical context, a faint world map 536 may be added to the background of the illustration. World map 536 may help emphasize the international nature of roaming and provide a sense of scale to the network interactions being depicted. It may also serve to illustrate the potential coverage areas of 5G Network HPLMN infrastructure 500 and the Partner 4G Network 512, helping to visualize scenarios where subscribers might move between these different network environments.

At the bottom of the illustration, a small timeline 538 is included to show the sequence of events in a typical roaming scenario from a 5G to a 4G network. This timeline may include steps such as initial attachment to the Partner 4G Network 512, authentication with the 5G Network HPLMN infrastructure 500, and service provisioning, helping to illustrate the chronological flow of roaming processes and the interworking between different generation networks.

A comprehensive legend 540 is provided, explaining symbols, line styles, and abbreviations used in the illustration. In the corner of the illustration, a small inset showing the Roaming Ratio Calculation 542 may be included. This inset might display the formula used to calculate the roaming ratio, emphasizing how the data collected from different network elements (such as the AMF 502, IMS S-CSCF 504, and partner MME 516) contributes to this key performance indicator.

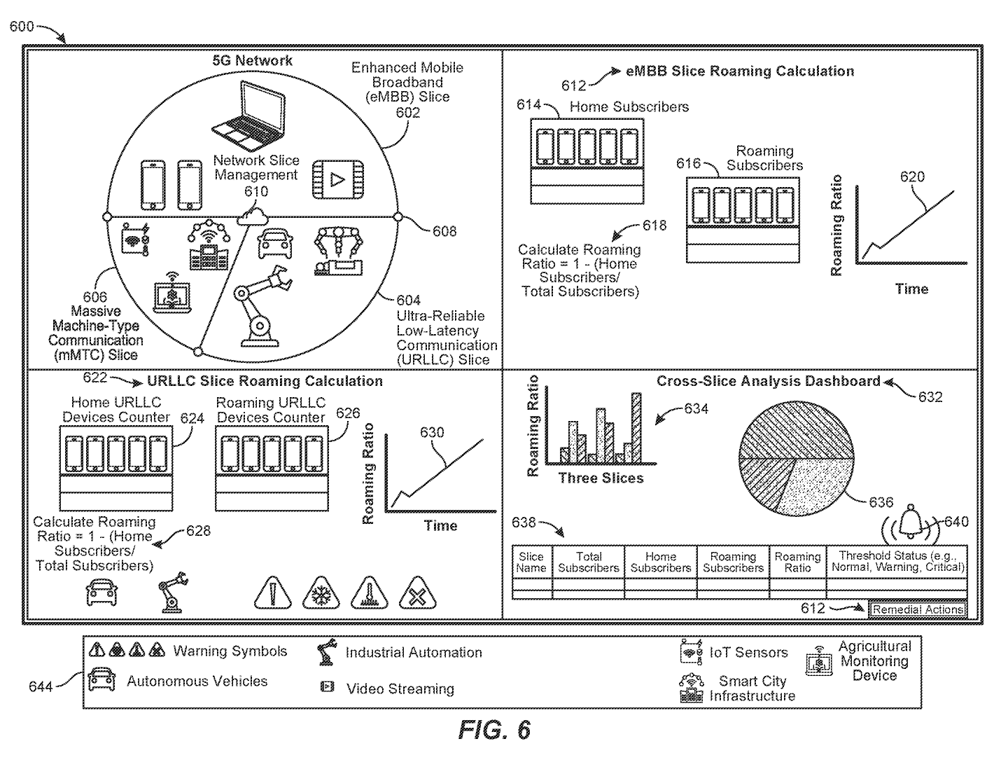

FIG. 6 illustrates a multi-panel representation of how roaming ratio calculations may be applied across different network slices and services in a 5G network environment. In some embodiments, this figure provides a view of the advanced capabilities of modern network architectures when using method 100 in managing and monitoring roaming activities across diverse use cases and service types.

The top left panel, including an Overall Network View 600, presents a large, circular diagram representing the entire 5G network. This circle is divided into three main sections, each representing a different network slice: Enhanced Mobile Broadband (eMBB) Slice 602, Ultra-Reliable Low-Latency Communication (URLLC) Slice 604, and Massive Machine-Type Communication (mMTC) Slice 606. The size of each section may reflect the relative proportion of network resources allocated to each slice, with eMBB Slice 602 potentially occupying the largest portion (around 50%), URLLC Slice 604 taking up about 30%, and mMTC Slice 606 comprising the remaining 20%. Within each slice, icons representing typical use cases are displayed. For eMBB Slice 602, these may include smartphones, laptops, and streaming video icons, illustrating the high-bandwidth, consumer-oriented nature of this slice. The URLLC Slice 604 section may show icons for autonomous vehicles, industrial robots, and remote surgery equipment, emphasizing the critical, low-latency applications supported by this slice. The mMTC Slice 606 portion may include representations of IoT sensors, smart city infrastructure, and agricultural monitoring devices, showcasing the large number of low-power, low-bandwidth devices typically associated with this slice. Around the periphery of the circle, small monitoring nodes 608 are placed, feeding into a central "Network Slice Management" icon 610 at the center of the circle. This arrangement visually demonstrates how data from various parts of the network is aggregated for comprehensive slice-aware monitoring and management.

The top right panel, focusing on eMBB Slice Roaming Calculation 612, provides a detailed view of how roaming ratios are computed and analyzed specifically for the eMBB Slice 602. This panel may be divided into subsections, with one area showing home subscribers 614 and another displaying roaming subscribers 616, each with its own counter. A formula display 618 in this panel shows the roaming ratio calculation specific to the eMBB slice 602, potentially using a modified version of the general roaming ratio formula to account for slice-specific considerations. Adjacent to this, a trending graph 620 illustrates how the eMBB roaming ratio has changed over time, potentially showing daily or weekly fluctuations. This graph may reveal patterns unique to eMBB usage, such as spikes during peak entertainment streaming hours or major events. The eMBB Slice Roaming Calculation 612 may take into account factors such as bandwidth consumption, quality of service requirements, and content delivery network interactions, all of which may influence roaming behavior in high-bandwidth scenarios.

The bottom left panel, illustrating URLLC Slice Roaming Calculation 622, mirrors the structure of the eMBB panel but focuses on the unique characteristics of Ultra-Reliable Low-Latency Communication. This panel includes a Home URLLC Devices Counter 624 and a Roaming URLLC Devices Counter 626, emphasizing the potentially different scale and nature of URLLC roaming compared to eMBB. A URLLC-specific roaming ratio formula 628 is displayed, which may incorporate additional parameters related to latency, reliability, and service continuity that are critical for URLLC applications. A URLLC roaming ratio trend graph 630 may show how this specialized roaming metric changes over time, potentially revealing patterns tied to industrial operations, telemedicine schedules, or autonomous vehicle traffic flows. Icons representing URLLC applications such as autonomous vehicles, industrial automation systems, and remote surgery equipment are included, with additional visual elements like warning symbols or "high priority" tags to emphasize the critical nature of these services. The URLLC Slice Roaming Calculation 622 may need to account for stringent service level agreements, ultra-low latency requirements, and/or the potential need for local breakout to minimize delay, all of which may significantly impact how roaming is managed and measured for this slice.

The bottom right panel, labeled as Cross-Slice Analysis Dashboard 632, presents a network operator's view for comparing and analyzing roaming patterns across all three network slices. A prominent feature of this panel is a bar graph 634 that compares roaming ratios across the eMBB, URLLC, and mMTC slices, enabling for quick visual identification of which slice may be experiencing higher levels of roaming activity. Adjacent to this, a pie chart 636 shows the distribution of roaming subscribers across the three slices, providing insight into the relative roaming load on each network segment. A detailed table 638 is included with columns for Slice Name, Total Subscribers, Home Subscribers, Roaming Subscribers, Roaming Ratio, and Threshold Status (e.g., Normal, Warning, Critical). This table offers a comprehensive numerical view of the roaming situation across slices, enabling for precise comparisons and trend identification. An alert section 640 within the dashboard highlights any slices or services that have exceeded their predefined roaming thresholds, potentially using visual cues like flashing icons or color-coded status indicators to draw attention to areas requiring immediate action. A "Remedial Actions" button 642 is prominently displayed, indicating the capability to initiate slice-specific or cross-slice interventions when roaming thresholds are exceeded. This button may be highlighted or animated when action is required, providing a clear call-to-action for network operators. At the bottom of FIG. 6, a comprehensive legend 644 is included to explain symbols, line styles, and abbreviations used across the panels.

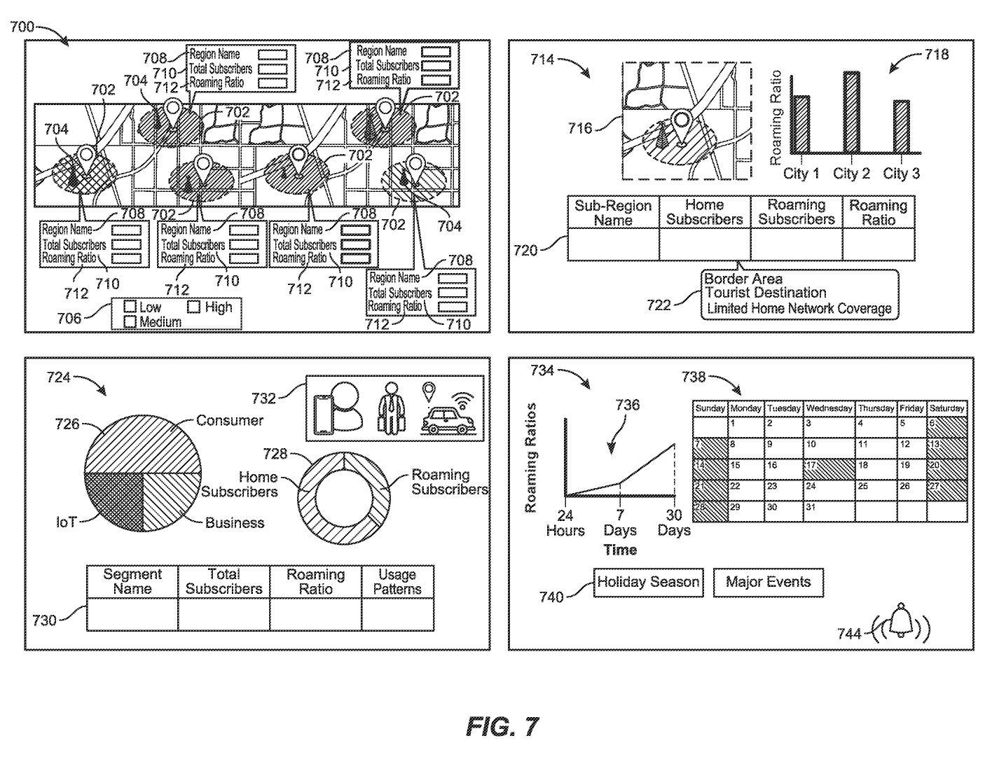

FIG. 7 presents a multi-panel illustration demonstrating the application of segmented roaming ratio analysis across different geographic regions and customer segments. This figure provides a comprehensive view of how mobile operators may gain granular insights into roaming patterns by analyzing data at various levels of specificity, enabling more targeted and effective network management strategies.

The top left panel, Geographic Segmentation Overview 700, offers a broad view of the mobile operator's coverage area, divided into multiple distinct geographical regions. This map-like representation includes at least six different geographical regions 702, each delineated and labeled. These regions may correspond to major metropolitan areas, states, or other logical divisions of the network's coverage area. Scattered across this map are icons representing cell towers 704, with varying densities to illustrate different levels of network coverage and capacity across regions. This visual representation enables for a quick assessment of network infrastructure distribution and potential coverage gaps that might influence roaming patterns.

A legend 706 is included in this panel, explaining the visual encoding used to represent different roaming ratio levels across the regions. For instance, different shading patterns or textures might be used to indicate low, medium, and high roaming ratios, providing an immediate visual cue to areas experiencing higher levels of roaming activity. Each region on the map is accompanied by a small information box displaying key metrics: the region name 708, total number of subscribers 710, and the current roaming ratio 712 for that specific area. This combination of visual and numerical data enables for quick identification of regions that may require attention due to elevated roaming levels.

The top right panel, focusing on Detailed Regional Analysis 714, zooms in on one specific region from the overview map to provide a more in-depth examination of roaming patterns within a smaller geographical area. This panel features a zoomed-in map of the selected region 716, showing more detailed network infrastructure such as individual cell sites, major roads, and potentially significant landmarks that might influence subscriber movement and roaming behavior. Overlaid on this map is a bar graph 718 comparing the roaming ratios of different sub-regions or cities within the selected area. This graph enables for easy visualization of how roaming activity varies across smaller geographical divisions, potentially highlighting localized issues or trends that might be obscured in the broader regional view.

Adjacent to the map in this panel is a small table 720 providing detailed numerical data for the sub-regions, including columns for sub-region name, number of home subscribers, number of roaming subscribers, and the calculated roaming ratio. This granular data enables precise comparison between different parts of the region and may help identify specific areas that may be contributing disproportionately to overall roaming activity. Surrounding the map and table may be instances of an example callout box 722 that highlight factors influencing roaming in this region. These may include notations such as "Border Area" to indicate proximity to international boundaries, "Tourist Destination" to explain seasonal fluctuations in roaming activity, or "Limited Home Network Coverage" to point out infrastructure gaps that may be driving higher roaming rates. These annotations provide context for the observed roaming patterns and may guide targeted interventions or network optimizations.

The bottom left panel, illustrating Customer Segmentation 724, shifts the focus from geographic analysis to examining how roaming behavior varies across different types of subscribers. Central to this panel is a large pie chart 726 showing the distribution of total subscribers across various segments, which includes categories such as Consumer, Business, and IoT (Internet of Things). This high-level segmentation provides an overview of the operator's subscriber base composition and sets the stage for more detailed roaming analysis by segment.

Adjacent the main pie chart 726 is an example instance of a smaller donut chart 728, which may be included for each customer segment, showing the proportion of home vs. roaming subscribers within that segment. These charts enable for quick visual comparison of roaming tendencies across different customer types, potentially revealing that certain segments (e.g., business customers) may have higher propensities for roaming than others. Accompanying these charts is a detailed table 730 that lists, for each segment, the total number of subscribers, the current roaming ratio, and usage patterns associated with that segment. This information helps contextualize the roaming data, tying it to specific customer behaviors and needs. To further illustrate the distinct characteristics of each customer segment, icons representing different customer types 732 are included. These examples show a smartphone user for the consumer segment, a business traveler for the enterprise segment, and a connected vehicle for the IoT segment. These visual representations help reinforce the unique needs and usage patterns of each customer type, which may significantly influence roaming behavior and management strategies.

The bottom right panel, Time-based Analysis Dashboard 734, provides a dynamic view of how roaming ratios evolve over time, both for the overall network and for specific regions or segments. A prominent feature of this panel is a line graph 736 showing roaming ratio trends over time, potentially covering the last 24 hours, 7 days, or 30 days. This graph may include multiple lines representing the overall network roaming ratio as well as the ratios for the top three regions identified in the geographic analysis, enabling for comparison of temporal patterns across different areas.

Below the trend line graph, a heatmap calendar 738 displays roaming intensity over the past month. Each day on this calendar is color-coded or shaded to indicate the level of roaming activity, with weekends and holidays highlighted to show their potential impact on roaming patterns. This visualization enables for easy identification of cyclical patterns, such as weekly fluctuations or holiday-related spikes in roaming activity.

A "Peak Roaming Periods" section 740 within this panel lists times when roaming ratios typically spike, such as during holiday seasons or major events. This information may help operators anticipate and prepare for periods of increased roaming activity. An alert section 744 is prominently displayed, highlighting any regions or segments currently exceeding predefined roaming thresholds. This real-time monitoring component ensures that operators may quickly identify and respond to unusual roaming activity across any dimension of their analysis.

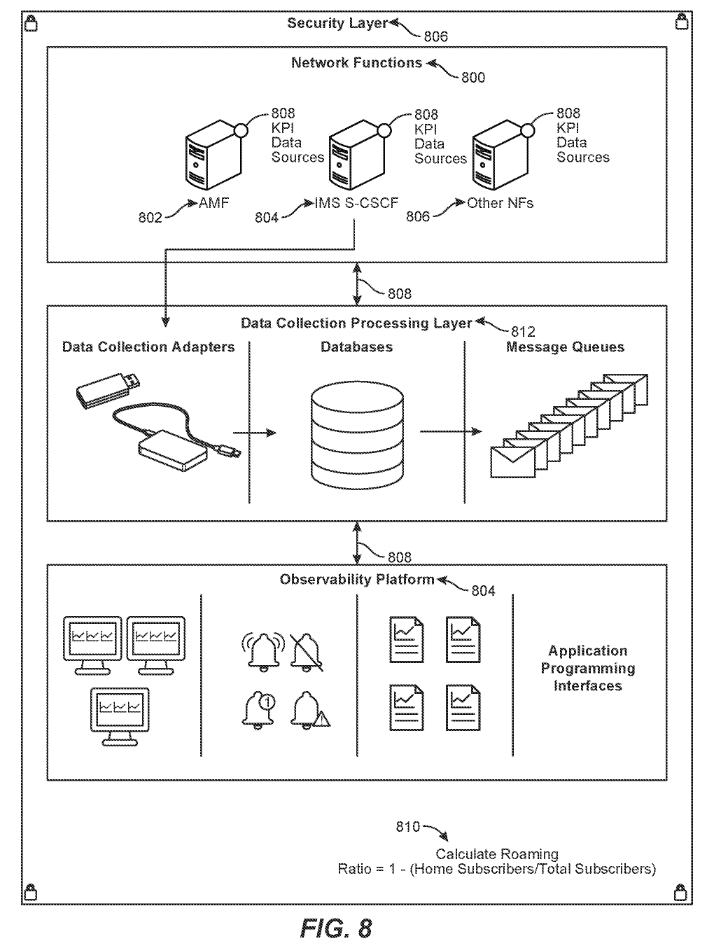

FIG. 8 presents a detailed illustration of an observability framework and Key Performance Indicator (KPI) data collection process that may be used in roaming ratio monitoring. This figure provides a comprehensive view of the data flow and processing stages that may be involved in gathering, analyzing, and presenting roaming-related metrics in a modern mobile network environment. The illustration is organized into four main sections, representing different layers of the observability framework, arranged vertically from top to bottom: Network Functions 800, Data Collection and Processing Layer 812, Observability Platform 804, and Security Layer 806. This vertical arrangement visually represents the potential flow of data from its sources in the network functions down through various processing stages to the final presentation and analysis layer.

At the top of the diagram, FIG. 8 shows the Network Functions section 800 displaying three server-like icons arranged in a row, which may represent components of the mobile network infrastructure. These icons are labeled from left to right as "AMF" (Access and Mobility Management Function) 802, "IMS S-CSCF" (IP Multimedia Subsystem Serving-Call Session Control Function) 804, and "Other NFs" (Network Functions) 806. Each of these server icons is adorned with small circles that represent data points or KPIs. This visual representation may emphasize the diverse sources of data within the network that could contribute to roaming ratio calculations and overall network performance monitoring. The inclusion of Other NFs 806 may indicate the potential extensibility of the system to incorporate data from additional network elements as needed. In practical implementations, these network functions may generate vast amounts of data related to subscriber activities, network performance, and roaming events. The AMF 802, for instance, could provide information about subscriber attachments, mobility events, and authentication processes, which may be crucial for identifying home and roaming subscribers. The IMS S-CSCF 804 might offer data on session establishments, service invocations, and multimedia communication patterns, potentially revealing insights into the usage behavior of both home and roaming subscribers. The Other NFs 806 category may encompass a wide range of additional network elements, such as the Session Management Function (SMF), User Plane Function (UPF), or Policy Control Function (PCF), each contributing unique datasets that could enrich the overall understanding of roaming patterns and network utilization.

Directly below the Network Functions, FIG. 8 illustrates the Data Collection and Processing Layer 812 as a large horizontal rectangle spanning the width of the diagram. This layer may play a crucial role in aggregating and processing the raw data from various network functions. Within this rectangle, three distinct subsections are shown: Data Collection Adapters, Databases, and Message Queues. The Data Collection Adapters, represented by icons on the left side of this layer, may serve as the interface between the raw data sources in the network functions and the processing systems. These adapters could be responsible for tasks such as data normalization, initial filtering, and protocol translation to ensure that data from diverse sources may be effectively combined and analyzed. In practice, these adapters might handle a wide variety of data formats and protocols. The adapters may also implement buffering mechanisms to handle bursts of data and ensure no information is lost during peak traffic periods. Additionally, they could perform initial data enrichment, adding contextual information or metadata that might facilitate subsequent analysis.

In the center of the Data Collection and Processing Layer, FIG. 8 shows cylinder shapes representing Databases. These databases may serve as both short-term buffers for incoming data and long-term storage for historical analysis. In some examples, the system may use distributed or specialized database systems optimized for different types of data or query patterns. In a production environment, these databases could be implemented using a combination of technologies tailored to the specific needs of roaming data analysis. For instance, time-series databases might be employed to efficiently store and query the large volumes of time-stamped data generated by network functions. Column-oriented databases could be used for analytical queries on historical data, while in-memory databases might handle real-time data processing for immediate insights. The database layer may also implement data partitioning and replication strategies to ensure high availability and fast query performance across large datasets.

On the right side of the Data Collection and Processing Layer 812, FIG. 8 illustrates connected blocks representing Message Queues. These queues may play a vital role in managing the flow of data through the system, potentially implementing patterns such as publish-subscribe models or load balancing across multiple processing nodes. The visual representation of these queues as interconnected blocks might emphasize their role in coordinating data flow and ensuring system scalability. In practice, these message queues could be implemented using distributed streaming platforms that may handle high-throughput, real-time data streams. They might support features such as persistent storage of messages, exactly-once delivery semantics, and the ability to replay historical data streams. The message queue system could also facilitate the decoupling of data producers (network functions) from data consumers (analysis and visualization components), enabling for greater flexibility and scalability in the overall system architecture.

Arrows drawn from the Network Functions to the Data Collection Adapters, and then to the Databases and Message Queues, illustrate the potential flow of data through this layer. These arrows may be styled differently to represent various types of data transfers or processing stages. In a real-world implementation, this data flow might involve multiple stages of transformation and enrichment. For example, raw data collected from network functions could undergo initial preprocessing in the collection adapters, then be published to message queues for real-time processing and alerting. Simultaneously, the data might be persisted to databases for long-term storage and historical analysis. The system could employ stream processing technologies to perform continuous computations on the data as it flows through the message queues, enabling real-time updating of key performance indicators (KPIs) and immediate detection of anomalies in roaming patterns.

Below the Data Collection and Processing Layer, FIG. 8 depicts the Observability Platform 804 as another large section. This platform may represent the interface through which network operators interact with the processed data and derive insights about roaming behavior and network performance. Within this section, several components are illustrated: dashboard interfaces represented by monitor icons displaying graphs and charts, an alert management system depicted by a bell icon, report generation tools shown as document icons with embedded charts, and an (application programming interface (API). The dashboard interfaces could provide real-time and historical views of roaming ratios, network performance metrics, and other KPIs relevant to roaming management. These dashboards might be built using modern data visualization libraries and support interactive features such as drill-down capabilities, custom time range selection, and the ability to correlate multiple metrics. The alert management system may be responsible for notifying operators of anomalies or threshold violations in roaming behavior or related network performance indicators. This system could employ sophisticated anomaly detection algorithms, potentially leveraging machine learning techniques to identify unusual patterns in roaming data that might not be captured by simple threshold-based alerts.

The report generation tools illustrated in FIG. 8 may enable for the creation of detailed analyses and summaries of roaming data, potentially for management review or regulatory compliance purposes. These tools could support a variety of output formats and offer capabilities such as scheduled report generation, custom templating, and the inclusion of automatically generated insights based on data analysis. The API interface shown in FIG. 8 might enable integration with other network management tools or custom applications developed by the operator. This API could be designed following RESTful principles, support authentication and authorization mechanisms, and offer various endpoints for querying roaming-related data and metrics.

The entire diagram in FIG. 8 is enclosed within a Security Layer 806, represented by a border around all other elements. At each corner of this border, small shield or lock icons are placed, which may symbolize the various security measures implemented to protect the sensitive data flowing through the system. This visual element might underscore the importance of data security and privacy in the roaming monitoring process. In practice, the security layer could encompass a wide range of technologies and practices, including encryption of data in transit and at rest, robust authentication and authorization mechanisms, regular security audits, and compliance with data protection regulations such as General Data Protection Regulation (GDPR) or California Consumer Privacy Act (CCPA).

Throughout the diagram, KPI Data Sources 808 are represented by arrows connecting various components. In a deployed system, these data flows could be managed by a combination of technologies, including high-speed message buses for real-time data movement, bulk data transfer mechanisms for large dataset migrations, and optimized database query patterns for efficient data retrieval.

In a corner of the diagram, FIG. 8 shows a KPI Calculation Example 810 provided in a callout box. This example displays the roaming ratio formula: "Roaming Ratio = 1 - (Home Subscribers / Total Subscribers)". The inclusion of this formula directly in the diagram may help to tie the data flows and processing steps to the concrete calculations that could drive roaming management decisions. In practice, this calculation might be one of many KPIs computed by the system. The actual implementation of such calculations could involve more complex logic to handle edge cases, such as adjusting for temporary network outages or accounting for subscribers in the process of handover between networks. The system might also compute related metrics, such as roaming revenue per subscriber, average duration of roaming sessions, or the ratio of inbound to outbound roamers.

The comprehensive nature of this observability framework illustration may emphasize the potential complexity involved in monitoring and analyzing roaming behavior in modern mobile networks. It showcases how data from diverse network elements could be collected, processed, and presented to enable near-real-time monitoring and informed decision-making regarding roaming management. The layered architecture depicted in the figure might enable for scalability and flexibility, potentially enabling mobile operators to adapt the system as network technologies evolve and roaming patterns change over time.

In practical deployments, such an observability framework could be implemented using a combination of off-the-shelf components and custom-developed software. For instance, the data collection adapters might be built using open-source data ingestion frameworks, while the message queues could be implemented using distributed streaming platforms. The databases might leverage a mix of specialized time-series databases for recent data and data warehousing solutions for long-term storage and analytics. The observability platform itself could be developed as a web-based application, potentially utilizing modern frontend frameworks for responsive and interactive user interfaces.

The system illustrated in FIG. 8 might also incorporate advanced analytics capabilities not explicitly shown in the diagram. These could include machine learning models for predicting future roaming patterns, anomaly detection algorithms for identifying unusual roaming behavior, and natural language processing techniques for generating human-readable insights from the vast amounts of collected data. Such advanced analytics could help mobile operators move from reactive to proactive management of roaming services, potentially improving both operational efficiency and customer experience.

Furthermore, while the figure focuses on roaming ratio monitoring, the architecture depicted could potentially be extended to support a wider range of network monitoring and management tasks. For example, similar data flows and processing stages might be used to monitor quality of service metrics, detect network fraud, or optimize resource allocation across the network. The modular nature of the illustrated system could enable for such extensions without requiring a complete overhaul of the existing infrastructure.

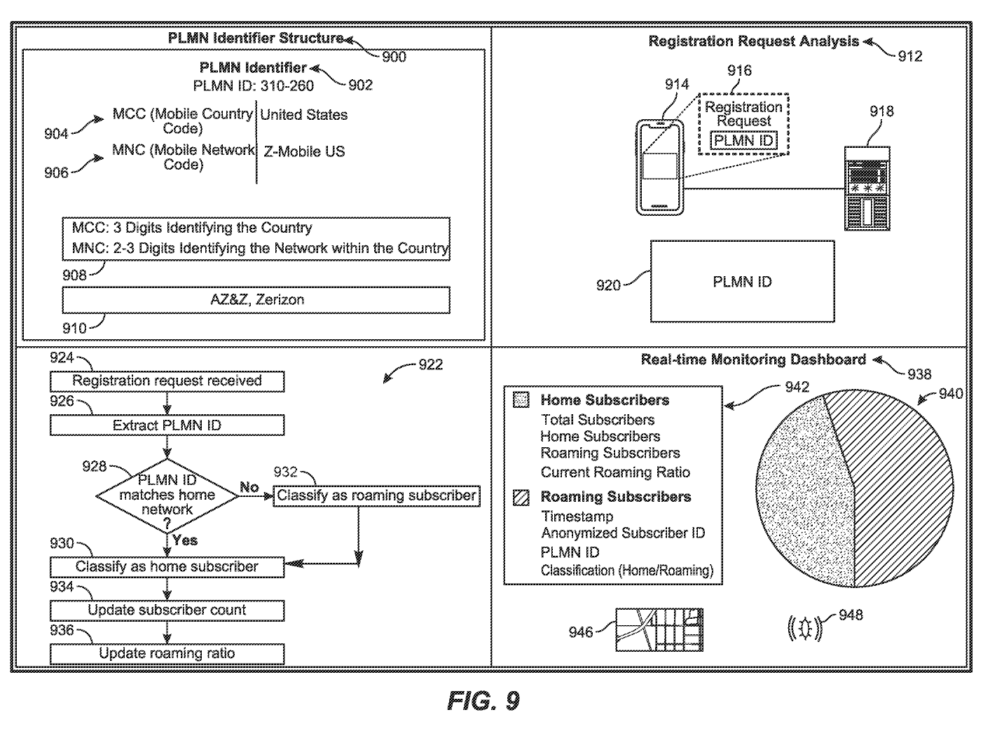

FIG. 9 presents a multi-panel illustration depicting the process of identifying home and roaming subscribers using Public Land Mobile Network (PLMN) identifiers. This figure provides a comprehensive view of how mobile operators may leverage standardized network identifiers to accurately classify subscribers and maintain up-to-date roaming statistics. The illustration is divided into four distinct panels, each focusing on a different aspect of the PLMN identifier-based classification process. The use of PLMN identifiers for this purpose represents a standardized technique that may enable interoperability between diverse network operators and technologies, facilitating seamless roaming experiences for subscribers while providing operators with insights into network usage patterns and roaming behaviors.

The top left panel of FIG. 9, labeled as PLMN Identifier Structure 900, offers a detailed breakdown of a PLMN identifier's composition. This panel shows a box representing the full PLMN identifier 902, labeled with an example identifier "PLMN ID: 310-260". The box is split into two sections to illustrate the two main components of a PLMN identifier: the Mobile Country Code (MCC) 904 and the Mobile Network Code (MNC) 906. In this example, the MCC is shown, which may correspond to the United States, while the MNC may represent a specific network operator within the country, such as Z-Mobil US. Adjacent to this visual representation, FIG. 9 includes a small legend 908 explaining the structure of PLMN identifiers. This legend may provide information such as "MCC: 3 digits identifying the country" and "MNC: 2-3 digits identifying the network within the country". The inclusion of this legend may help viewers understand the standardized format of PLMN identifiers and their significance in network identification. Furthermore, the panel may display examples 910 of PLMN IDs for other major operators, potentially including identifiers for carriers like AZ&Z or Forison, as well as international examples. This additional context could help illustrate the global applicability of the PLMN identifier system and its role in facilitating international roaming. The PLMN identifier structure plays a role in the functioning of mobile networks worldwide, serving as a unique identifier for each network operator. This standardized system, managed by international telecommunications authorities, ensures that each network may be uniquely identified across borders, facilitating interoperability and roaming agreements between operators. The structure of these identifiers is designed to accommodate the global scale of mobile communications while providing sufficient granularity to distinguish between multiple operators within a single country. In practice, mobile devices store these PLMN identifiers as part of their configuration, using them to identify home networks and potential roaming partners as subscribers move between coverage areas.

The top right panel of FIG. 9, focusing on Registration Request Analysis 912, illustrates the process of extracting PLMN information from a registration request. This panel shows a simplified smartphone 914 sending a registration request, visually representing a subscriber device attempting to connect to a network. A zoomed-in view of the registration request message 916 is provided, with the PLMN ID field highlighted to emphasize its importance in the classification process. An arrow points from this request to a server icon representing the network function 918 receiving the request, which could be an element such as the Access and Mobility Management Function (AMF) in a 5G network. The panel also displays a text box 920 for the step where the PLMN ID is extracted and compared to a stored list of home network PLMN IDs. This visual representation underscores the automated nature of the classification process, where incoming registration requests are analyzed in real-time to determine the subscriber's home or roaming status. In an actual implementation, this process might involve sophisticated pattern matching algorithms and high-performance database queries to ensure rapid classification even under high network load conditions. The registration request analysis process is a component of mobile network operations, which may occur countless times each day as subscribers move between coverage areas or power on their devices. This process not only facilitates the basic connectivity of devices to the network but also plays a role in subscriber classification, mobility management, and the application of appropriate policies and services. The extraction and analysis of the PLMN ID from these registration requests enable network operators to make instantaneous decisions about how to handle each connection attempt, determining whether to treat the subscriber as a home customer or a roamer, and applying the appropriate authentication, authorization, and accounting procedures accordingly.

The bottom left panel of FIG. 9 presents a Subscriber Classification Flow 922, offering a flowchart-style representation of the decision-making process involved in classifying subscribers. The flowchart begins with a "Registration Request Received" box 924, indicating the initiation of the classification process upon receipt of a subscriber's registration attempt. An arrow leads to an "Extract PLMN ID" box 926, representing the system's action to isolate the PLMN identifier from the incoming request. The core of this flowchart is a decision diamond labeled "PLMN ID matches Home Network?" 928. This decision point illustrates the comparison that determines whether a subscriber is classified as a home subscriber or a roaming subscriber. Two arrows emanate from this diamond: one leading to a "Classify as Home Subscriber" box 930 for PLMN IDs matching the home network, and another to a "Classify as Roaming Subscriber" box 932 for non-matching PLMN IDs. "Update Subscriber Count" box 934 represents the system's action to maintain accurate tallies of home and roaming subscribers. The flowchart concludes with an "Update Roaming Ratio" box 936, indicating that the classification of each subscriber contributes to the ongoing calculation of the network's roaming ratio.

This flowchart, while simplified for visual clarity, represents a process that may involve multiple layers of logic and error handling in actual implementation. For example, the system might incorporate additional checks to validate the integrity of the received PLMN ID, handle edge cases such as subscribers with multiple associated PLMN IDs, or manage scenarios where network sharing agreements complicate the definition of "home" and "roaming" subscribers. The subscriber classification process illustrated in this flowchart is one operation in mobile network management, which may occur continuously as subscribers move and interact with the network. This process not only enables the basic functionality of roaming but also provides valuable data for network planning, resource allocation, and business intelligence. The real-time nature of this classification enables network operators to maintain an up-to-the-minute understanding of their subscriber base composition, informing decisions ranging from network capacity planning to roaming agreement negotiations.

The bottom right panel of FIG. 9 illustrates a Real-time Monitoring Dashboard 938, providing a network operator's view of the ongoing classification process and its outcomes. Central to this panel is a large pie chart 940 showing the current split of home versus roaming subscribers, offering an at-a-glance view of the network's subscriber composition. Adjacent to this, a real-time counter 942 displays metrics including Total Subscribers, Home Subscribers, Roaming Subscribers, and the Current Roaming Ratio. These counters may be designed to update dynamically, reflecting the continuous nature of the classification process and its impact on overall network statistics. The panel also includes a scrolling list of recent classifications, showing details such as Timestamp, Anonymized Subscriber ID, PLMN ID, and Classification (Home/Roaming) for each processed registration request. This list could provide operators with insights into the moment-by-moment changes in subscriber status and help identify any unusual patterns or sudden shifts in roaming activity. A small map 946 within the dashboard shows the geographical distribution of recent roaming subscriber registrations, potentially using dot density or heat map visualization techniques to indicate areas with higher concentrations of roaming activity. This geographical representation may assist operators in identifying localized spikes in roaming that could indicate events, coverage issues, or other factors influencing subscriber behavior. An alert section 948 is prominently displayed, designed to highlight when the roaming ratio exceeds predefined thresholds. This feature underscores the system's capability to not only classify subscribers but also to monitor the overall network state and flag situations that may require operator attention or intervention. The real-time monitoring dashboard represents the culmination of the PLMN identifier-based classification process, transforming raw network data into actionable insights for network operators. This type of dynamic, data-rich interface enables operators to maintain a comprehensive understanding of their network's status and composition, facilitating rapid response to changing conditions and informed decision-making.

Moreover, while the figure focuses on the use of PLMN identifiers, actual implementations might incorporate additional data points to refine the classification process. For instance, the system might consider factors such as the subscriber's historical behavior, current location relative to known coverage areas, or specific attributes of the service being requested. This multi-faceted technique could enhance the accuracy of classifications and provide a more nuanced understanding of subscriber behavior in complex roaming scenarios, such as in border areas where network coverage may overlap, or in cases of network sharing agreements between operators. By combining PLMN identifier-based classification with these additional data points, mobile operators may develop highly sophisticated systems for managing roaming, optimizing network resources, and delivering personalized services to subscribers, regardless of their location or the network they are connecting through.

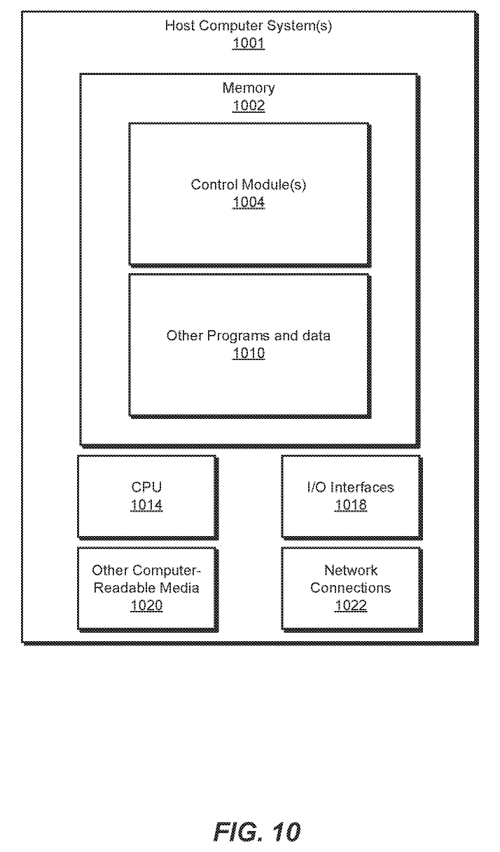

FIG. 10 shows a system diagram that describes an example implementation of a computing system(s) for implementing embodiments described herein. The functionality described herein may be implemented either on dedicated hardware, as a software instance running on dedicated hardware, or as a virtualized function instantiated on an appropriate platform, e.g., a cloud infrastructure. In some embodiments, such functionality may be completely software-based and designed as cloud-native, meaning that they are agnostic to the underlying cloud infrastructure, enabling higher deployment agility and flexibility. However, FIG. 10 illustrates an example of underlying hardware on which such software and functionality may be hosted and/or implemented.

In particular, shown is example host computer system(s) 1001. For example, such computer system(s) 1001 may execute a scripting application, or other software application, as further discussed above, and/or to perform one or more of the other methods described herein. In some embodiments, one or more special-purpose computing systems may be used to implement the functionality described herein. Accordingly, various embodiments described herein may be implemented in software, hardware, firmware, or in some combination thereof. Host computer system(s) 1001 may include memory 1002, one or more central processing units (CPUs) 1014, I/O interfaces 1018, other computer-readable media 1020, and network connections 1022.

Memory 1002 may include one or more various types of non-volatile and/or volatile storage technologies. Examples of memory 1002 may include, but are not limited to, flash memory, hard disk drives, optical drives, solid-state drives, various types of random access memory (RAM), various types of read-only memory (ROM), neural networks, other computer-readable storage media (also referred to as processor-readable storage media), or the like, or any combination thereof. Memory 1002 may be utilized to store information, including computer-readable instructions that are utilized by CPU 1014 to perform actions, including those of embodiments described herein.

Memory 1002 may have stored thereon control module(s) 1004. The control module(s) 1004 may be configured to implement and/or perform some or all of the functions of the systems or components described herein. Memory 1002 may also store other programs and data 1010, which may include rules, databases, application programming interfaces (APIs), software containers, nodes, pods, clusters, node groups, control planes, software defined data centers (SDDCs), microservices, virtualized environments, software platforms, cloud computing service software, network management software, network orchestrator software, network functions (NF), artificial intelligence (AI) or machine learning (ML) programs or models to perform the functionality described herein, user interfaces, operating systems, other network management functions, other NFs, etc.

Network connections 1022 are configured to communicate with other computing devices to facilitate the functionality described herein. In various embodiments, the network connections 1022 include transmitters and receivers (not illustrated), cellular telecommunication network equipment and interfaces, and/or other computer network equipment and interfaces to send and receive data as described herein, such as to send and receive instructions, commands and data to implement the processes described herein. I/O interfaces 1018 may include a video interface, other data input or output interfaces, or the like. Other computer-readable media 1020 may include other types of stationary or removable computer-readable media, such as removable flash drives, external hard drives, or the like.

The various embodiments described above may be combined to provide further embodiments. These and other changes may be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method comprising:
receiving, by a mobile operator of at least a fifth generation HPLMN, a first API response to a first KPI API call that specifies a number of home subscribers registered with a first NF of the HPLMN and a second API response to a second KPI API call that specifies a total number of subscribers registered with a second and distinct NF of the HPLMN such that the total number of subscribers includes both home subscribers and roaming subscribers that are roaming on a VPLMN;
computing, by the mobile operator, a ratio of home subscribers to total subscribers by comparing the number of home subscribers registered with the first NF as indicated by the first API response to the total number of subscribers registered with the second and distinct NF as indicated by the second API response such that the ratio represents a percentage of subscribers that are home subscribers;
performing, by the mobile operator in response to a determination that the ratio satisfies a predetermined threshold, a remediation action that resolves an alert resulting from an elevated number of roaming subscribers registered with the second and distinct NF as indicated by the ratio satisfying the predetermined threshold.

2. The method of claim 1, wherein the first KPI API call comprises a call provided by the first NF.

3. The method of claim 1, wherein the second KPI API call comprises a call provided by the second and distinct NF.

4. The method of claim 1, wherein the first NF manages connections and mobility for home subscribers on the HPLMN.

5. The method of claim 4, wherein the first NF comprises an AMF.

6. The method of claim 1, wherein the second and distinct NF comprises an IMS S-CSCF.

7. The method of claim 1, wherein the first NF has no visibility into a number of roaming subscribers currently registered on the VPLMN.

8. The method of claim 1, further comprising computing a ratio of roaming subscribers to total subscribers by subtracting the ratio of home subscribers to total subscribers from one.

9. The method of claim 1, wherein the predetermined threshold comprises a threshold between 15 and 35 percent.

10. The method of claim 1, wherein the remediation action comprises at least one of: checking for outages in a RAN, verifying interconnectivity between the HPLMN and partner networks, or examining authentication processes for roaming subscribers.

11. The method of claim 10, wherein the remediation action comprises restoring service to an impaired portion of the RAN of the HPLMN.

12. The method of claim 1, wherein the mobile operator computes the ratio at predefined intervals.

13. The method of claim 12, wherein the mobile operator computes the ratio at intervals between 1 and 30 minutes.

14. The method of claim 1, wherein:
the HPLMN comprises a network distributed across multiple availability zones of a cloud computing platform; and
the mobile operator computes the ratio separately for each availability zone such that the mobile operator detects elevated roaming levels specific to individual availability zones.

15. The method of claim 1, wherein the mobile operator collects the KPIs using an observability framework.

16. The method of claim 1, wherein:
the mobile operator identifies home subscribers and roaming subscribers by extracting PLMN identifiers from registration request messages received from subscriber devices; and
the mobile operator compares the extracted identifiers to a stored identifier of the HPLMN to determine subscriber roaming status.

17. A non-transitory computer-readable storage medium having computer-executable instructions stored thereon that, when executed by at least one processor, cause the at least one processor to cause operations to be performed, the operations including:
receiving, by a mobile operator of at least a fifth generation HPLMN, a first API response to a first KPI API call that specifies a number of home subscribers registered with a first NF of the HPLMN and a second API response to a second KPI API call that specifies a total number of subscribers registered with a second and distinct NF of the HPLMN such that the total number of subscribers includes both home subscribers and roaming subscribers that are roaming on a VPLMN;
computing, by the mobile operator, a ratio of home subscribers to total subscribers by comparing the number of home subscribers registered with the first NF as indicated by the first API response to the total number of subscribers registered with the second and distinct NF as indicated by the second API response such that the ratio represents a percentage of subscribers that are home subscribers;
performing, by the mobile operator in response to a determination that the ratio satisfies a predetermined threshold, a remediation action that resolves an alert resulting from an elevated number of roaming subscribers registered with the second and distinct NF as indicated by the ratio satisfying the predetermined threshold.

18. The non-transitory computer-readable storage medium of claim 17, wherein the first KPI API call comprises a call provided by the first NF and the second KPI API call comprises a call provided by the second and distinct NF.

19. A system comprising:
at least one memory that stores computer executable instructions; and
at least one processor that executes the computer executable instructions to cause operations to be performed, the operations including:
receiving, by a mobile operator of at least a fifth generation HPLMN, a first API response to a first KPI API call that specifies a number of home subscribers registered with a first NF of the HPLMN and a second API response to a second KPI API call that specifies a total number of subscribers registered with a second and distinct NF of the HPLMN such that the total number of subscribers includes both home subscribers and roaming subscribers that are roaming on a VPLMN;
computing, by the mobile operator, a ratio of home subscribers to total subscribers by comparing the number of home subscribers registered with the first NF as indicated by the first API response to the total number of subscribers registered with the second and distinct NF as indicated by the second API response such that the ratio represents a percentage of subscribers that are home subscribers;
performing, by the mobile operator in response to a determination that the ratio satisfies a predetermined threshold, a remediation action that resolves an alert resulting from an elevated number of roaming subscribers registered with the second and distinct NF as indicated by the ratio satisfying the predetermined threshold.

20. The system of claim 19, wherein the first KPI API call comprises a call provided by the first NF and the second KPI API call comprises a call provided by the second and distinct NF.
